(19) United States
(12) Patent Application Publication
(10) Pub. No.: US 2015/0236743 A1
(43) Pub. Date: Aug. 20, 2015

(54) PRIVACY AND PROTECTION CASE FOR MOBILE DEVICES

(71) Applicant: Marc Kennedy, San Francisco, CA (US)

(72) Inventor: Marc Kennedy, San Francisco, CA (US)

(21) Appl. No.: 14/182,203

(22) Filed: Feb. 17, 2014

(51) Int. Cl. H04B 1/3888; H04M 1/02; H04R 1/02

(52) U.S. Cl. CPC H04B 1/3888; H04R 1/028; H04M 1/0202; H04R 2499/11; H04R 2499/15

(57) ABSTRACT

The new invention provides a system for privacy protection from unauthorized and unintentional camera and microphone access for a host user device. The system includes at least one user-enabled privacy means, said system comprising at least one sound generator, such as a white noise maker, associated with at least one speaker, said sound generator being configured to selectively operate in one of two states: a first state enabling sound generation and a second state disabling sound generation; a notifier for the active operational state; and user-controlled front and rear camera masking means.

### CROSS-REFERENCE TO RELATED APPLICATIONS

None.

### FEDERALLY-SPONSORED RESEARCH

Not applicable.

### SEQUENCE LISTING

Not applicable.

### BACKGROUND OF THE INVENTION

The invention is concerned with systems and methods for privacy protection by manual user control of one or more masking means for cameras and microphones on mobile user devices. It is known that mobile devices, particularly smartphones and tablets, can be activated in one's pocket, purse or briefcase and, generally, at inopportune moments. It is also known that technology exists by which an individual or entity can remotely and without a user's authorization activate a user's mobile device and utilize its sensory equipment (e.g., camera and microphone). However, it has not been possible heretofore to easily and seamlessly prevent unauthorized users or unwitting recipients of inadvertent phone calls from receiving audio or photographic data from the user's device once access to the user's device is made.

There are few existing systems designed to prevent remote, unauthorized collection of data from one's mobile device, but devices are not user-enabled and, thus, fail to provide the user with confidence that the device is active when privacy is desirable. Notably, the system and method disclosed in patent application no. WO2013144966 A1 provides an automated privacy system that both senses attempted remote, unauthorized activation of a user device and controls operability of the communication sensors of the user device. In other words, such system requires not only interaction with user device's operating system, it actually must be integrated into the phone's hardware and software design. Given the abundance and variety of mobile device available on the market today, it is unrealistic to expect that such system can and will be built into even the most popular devices anytime soon. In any event, such protection by the WO2013144966 A1 system is not—and cannot be—made available on-demand or even for one's current mobile device. Further, such system is quite limited in terms of user control and does not address the problem of inadvertent calling or photographing.

### SUMMARY OF THE INVENTION

Since any mobile device privacy system requiring control of the device's integral components is, at least at present, not readily available and not available on all existing user devices, there is a need for a mobile device privacy system that effectively masks a device's sensor components as to render useless and unidentifiable any data that may be remotely collected. Thus, in accordance with a first embodiment of the invention, the present invention provides a system whereby manual means can be employed by a user to mask a device's sensors. Said system is integrated into a relatively standard size mobile device case. Such manual masking means may include a noise generator connected to a speaker located in close proximity to the device's microphone such that, for example, very low level white noise serves to distort any audio that may be remotely or inadvertently transmitted when the user is not intentionally utilizing the microphone function of the device. Another such masking means is a shutter mechanism integrated into the case and positioned over each camera lens in the target mobile device thereby enabling the user to render blank any photographic or video images transmitted inadvertently or without the user's authorization.

Generally, this application relates to cases for portable electronic devices, and more particularly, to cases that may be used to prevent unauthorized collection of photograph, video, audio recordings and the like via remote use of a portable electronic device's (or, more simply, a “device”) speaker and camera functions. As used herein, the term “portable electronic device” may include any type of wireless communication devices, such as, e.g., mobile telephone, tablet, portable computer, gaming device, media player, smartphone, personal organizer, and the like.

The system is incorporated into a case that may be designed to protect a device from collisions or impacts. The case may be designed to attempt to protect a device from contaminants or contamination. Such contaminants or contamination may include liquids, particulates, heat, cold, moisture, humidity, dirt, dust, and/or any other externally generated influence that may compromise the functionality of the device. A case may also be designed to protect interactive parts of the device (for example, touch screen) from scratching. A case may further be designed with an integral solar charging mechanism by which either or both the battery charging the phone and the battery charging the noise generator can be supplementally charged via solar power.

The sum of these advantages unify with the novel article of the new mobile device privacy and protection system, resulting in an invention that is not anticipated, rendered obvious, suggested, or even implied by any of the prior art support, either alone or in any combination thereof.

These, together with other objects of the invention, along with the various features of novelty characterizing the invention, are described with particularity in the claims herewith. A more comprehensive understanding of the features, operation and uses of the invention may be gleaned from reference to the enclosed drawings and descriptive matter further illustrating the preferred embodiments of the invention.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. It should be further understood that the phraseology and terminology applied herein merely serve the purpose of description and should not be regarded as limiting.

### BRIEF DESCRIPTION OF THE DRAWINGS

FIGS. 1A and 1B depict one embodiment of the front of the privacy case, in operational position on a smartphone, showing the shutter-closed and shutter-open positions, respectively.

FIGS. 2A and 2B depict horizontal cross-sections of one embodiment of the privacy case.

FIGS. 3A and 3B depict the inside of the backside under the tray and the inside of the tray of one embodiment of the privacy case, respectively. FIG. 3C depicts a side-vertical cross-section of one embodiment of the privacy case.

FIGS. 4A and 4B depict the inside of the backside under the tray and the inside of the tray of another embodiment of the privacy case, respectively. FIG. 4C depicts a side-vertical cross-section of another embodiment of the privacy case.

FIGS. 5A and 5B depict one embodiment of the back of the privacy case, in operational position on a smartphone, showing the shutter-closed and shutter-open positions, respectively.

FIGS. 6A and 6B depict the top and bottom of one embodiment of the privacy case, respectively. FIGS. 6C and 6D depict the closed-flap and open-flap positions of the bottom of another embodiment of the privacy case, respectively.

FIGS. 7A and 7B depict left and right side views, respectively, of the privacy case.

### DESCRIPTION OF THE PREFERRED EMBODIMENT

In accordance with this invention, it is now possible for a mobile device user to optionally and manually mask the content of data remotely acquired or inadvertently transmitted from a user's mobile device. Further, the new system enables a user to easily and independently control the audio and visual privacy functions with confidence that the desired function is enabled.

The following example is submitted to illustrate but not to limit this invention.

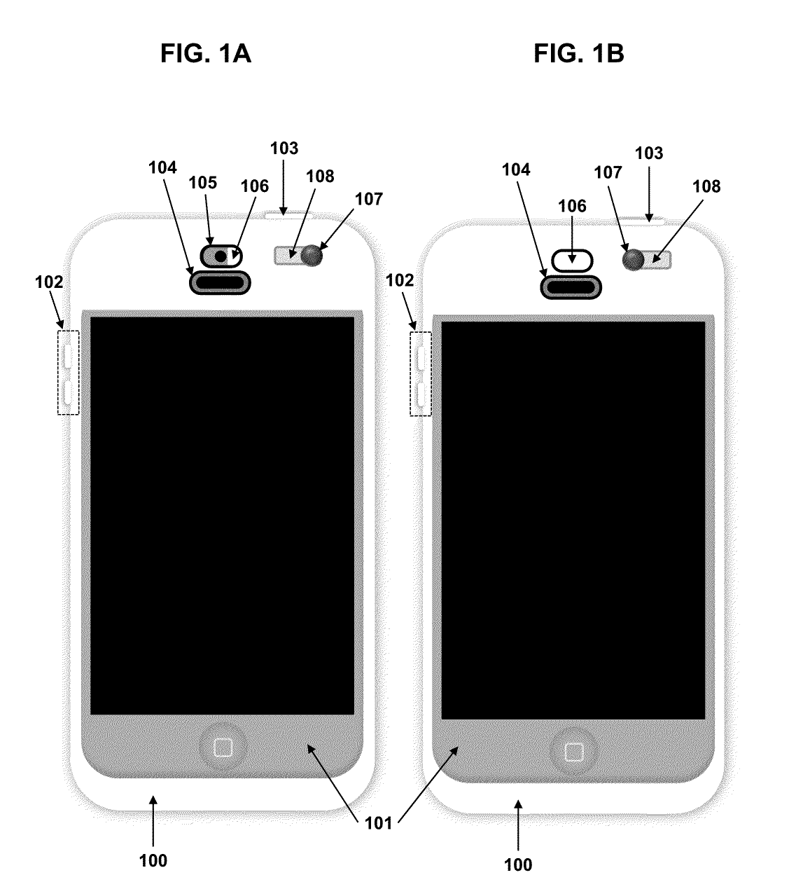

FIGS. 1A and 1B collectively illustrate one embodiment of the privacy case 100 in operational position on a smartphone mobile device 101 having allowances for volume controls 102 (e.g., covers or holes), allowance for the device's power button 103, and a cutout for the device's speaker 104. FIG. 1A shows the front view of the privacy case with a front visual privacy component, a shutter 106, in non-operative position relative to a front mobile device camera lens 105 exposed via a cutout—which may be open or contain a transparent material for better protection of the device—in the privacy case 100 to enable user-elected camera use. FIG. 1B shows the front view of the privacy case with a front visual privacy component, a shutter 106, in operative position as to fully obstruct visual data collection from a mobile device's front camera. To the right of the privacy shutter 106 is a privacy shutter control mechanism whereby a user-controlled slidable switch 107 can be moved side-to-side in a switch track 108, thus causing the privacy shutter to open and close as desired. FIG. 1A depicts the switch 107 in open position on the track 108, and FIG. 1B depicts the switch 107 in closed position on the track 108.

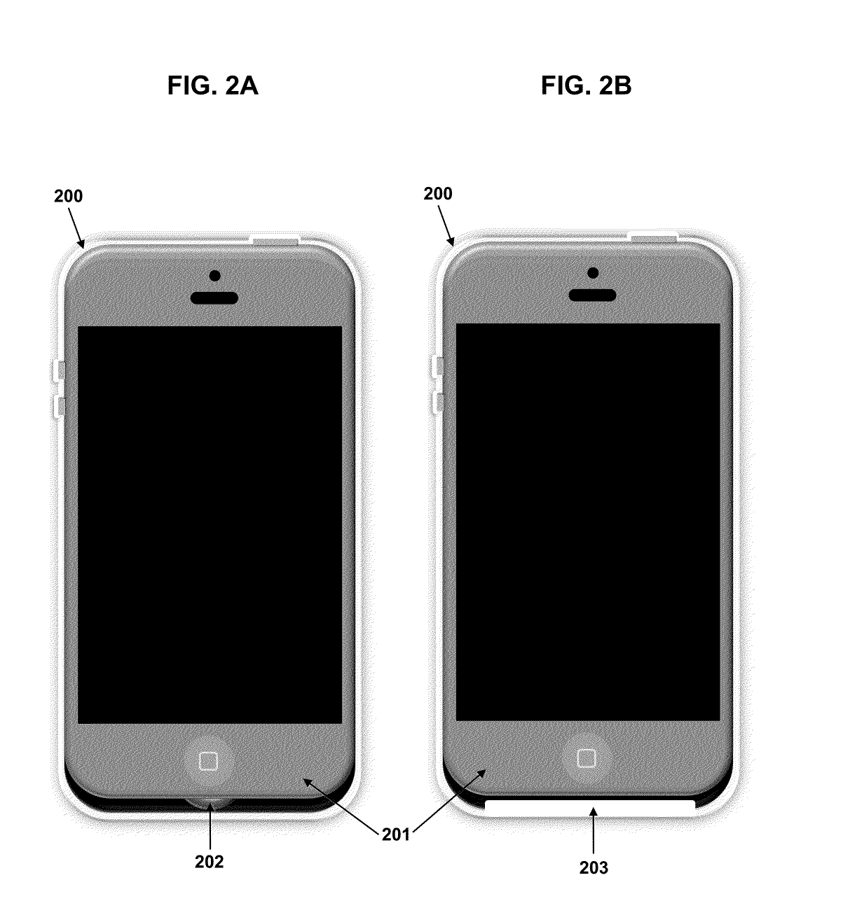

FIGS. 2A and 2B collectively illustrate a horizontal cross-section of one embodiment of the privacy case 200 in operational position on a smartphone mobile device 201. FIG. 2A. depicts, generally, a “unified” embodiment of the privacy system whereby the noise-emitting speaker 202 can be seen in its stationary position beneath and adjacent to the microphone of the user device. FIG. 2B. depicts, generally, a “gated” embodiment of the privacy system whereby a hinged gate 203 is positioned at the bottom of the case 200, which serves to control activation of the noise-emitter, as discussed below, and which disguises the speaker in this particular depiction.

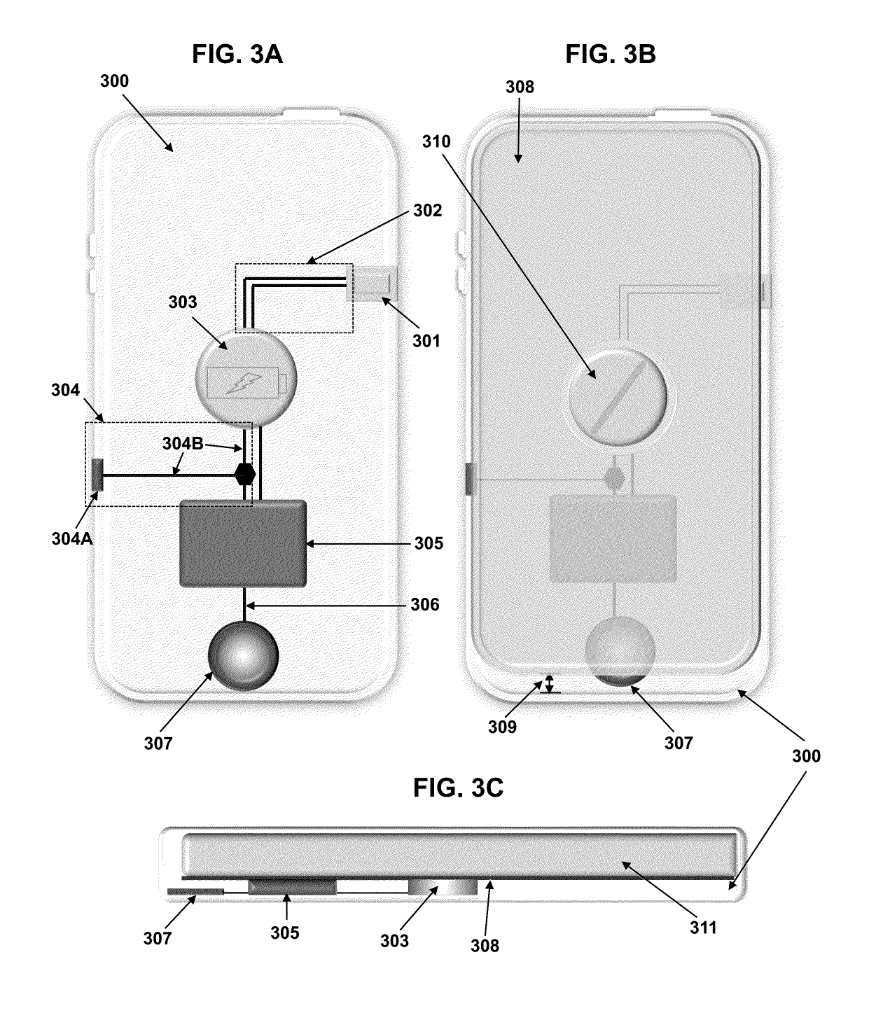

FIGS. 3A, 3B and 3C collectively illustrate the components of the unified embodiment of the privacy case. FIG. 3A illustrates the electrical components of the system as embedded in the primary casing 300 of the privacy case. An optional charging port 301, which may be a micro USB or any other standard or customized power port type, is located in proximity to the edge of the case and is connected via electrical circuitry 302 to a battery 303, which is further connected through a user-controlled circuit 304 to a noise generator 305 and, via said noise generator 305 and additional electric circuitry 306, to a micro speaker 307. In the depicted unified embodiment, the audible privacy feature is active by default. In other words, when the device is not in use by the user, the noise-generator is on and the audio privacy function is working. The user-controlled circuit 304 provides a user-accessible means 304A to optionally and temporarily intercept (or break) the circuit 304B between the battery 303 and noise-generator 305, such as by touching or squeezing the user accessible means 304A.

FIG. 3B depicts a “tray” 308 having an inner length and width of the target user device and outer dimensions enabling it to fit snuggly into the casing 300 of the privacy case, leaving a gap 309 between the tray and the bottom of the casing, which enables the speaker 307 diaphragm to move and, thus, to operate efficiently. FIG. 3B further depicts a battery replacement mechanism 310 for removing the noise-generator's power supply.

FIG. 3C illustrates a vertical, latitudinal cross-section of the system depicting the tray 308 positioned inside the privacy system's casing 300 and beneath a user device 310. Within the casing 300 is illustrated the relative positions of the battery 303, noise-generator 305 and speaker 307. When the system is active, the emitted noise level may vary, but an example acceptable level is 20-24 decibel, which is roughly equivalent to a very low whisper.

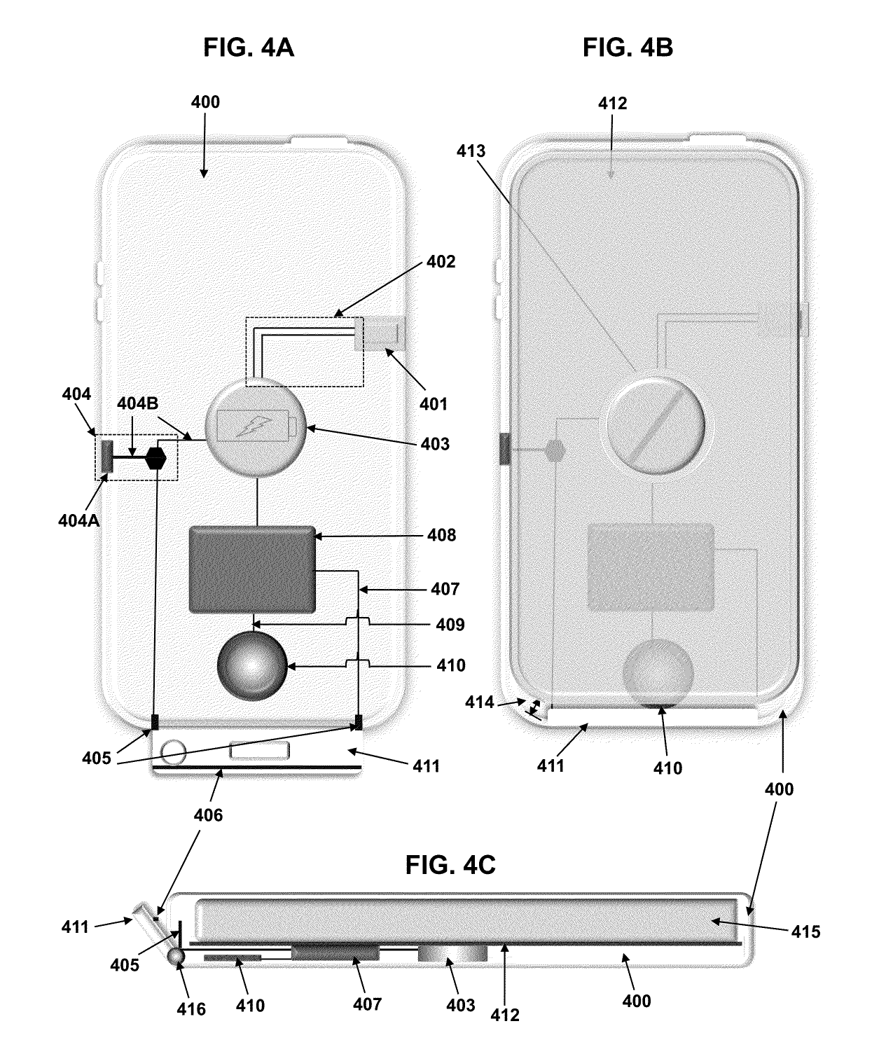

FIGS. 4A and 4B collectively illustrate the components of the gated embodiment of the privacy case. FIG. 4A illustrates the electrical components of the system as embedded in the primary casing 400 of the privacy case. An optional charging port 401, which may be a micro USB or any other standard or customized power port type, is located in proximity to the edge of the case and is connected via electrical circuitry 402 to a battery 403, which is further connected through a user-controlled circuit 404 to a first circuit end means opposing a second circuit end means, together considered the end means 405, which is connected via electrical circuitry 407 to a noise generator 408 and, via said noise generator 408 and additional electric circuitry 409, to a micro speaker 410. The user-controlled circuit 404 provides a user-accessible means 404A to optionally and temporarily intercept (or break) the circuit 404B between the battery 403 and noise-generator 408, such as by touching or squeezing the user accessible means 404A. In the depicted gated embodiment, the audio privacy feature is inactive (i.e., not generating pink or white noise) when the gate 411 located at the bottom of the case is open. When the gate 411 is closed, a circuit connecting means 406 makes contact with both circuit end means 405, thereby connecting the circuit and enabling the battery 403 to power the noise-generator 408. In other words, when the device is not in use by the user, the user closes the gate, thereby turning on the noise-generator and activating the audio privacy function.

FIG. 4B depicts a “tray” 412 having an inner length and width of the target user device and outer dimensions enabling it to fit snuggly into the casing 400 of the privacy case, leaving a gap 414 between the tray and the bottom of the casing, which enables the speaker 410 diaphragm to move and, thus, to operate efficiently. FIG. 4B further depicts a battery replacement mechanism 413 for removing the noise-generator's power supply.

FIG. 4C illustrates a vertical, latitudinal cross-section of the system depicting the tray 412 positioned inside the privacy system's casing 400 and beneath a user device 415. Within the casing 400 is illustrated the relative positions of the battery 403, noise-generator 407 and speaker 410. The user-controlled gate 411 is connected to the casing 400 by a hinge 416, such that the gate opens from the front-end, thereby breaking or completing the audio masking circuit when the circuit connecting means 406 located on the gate 411 makes contact with the circuit end means 405 located on the casing 400. When the system is active, the emitted noise level may vary, but an example acceptable level is 20-24 decibel, which is roughly equivalent to a very low whisper.

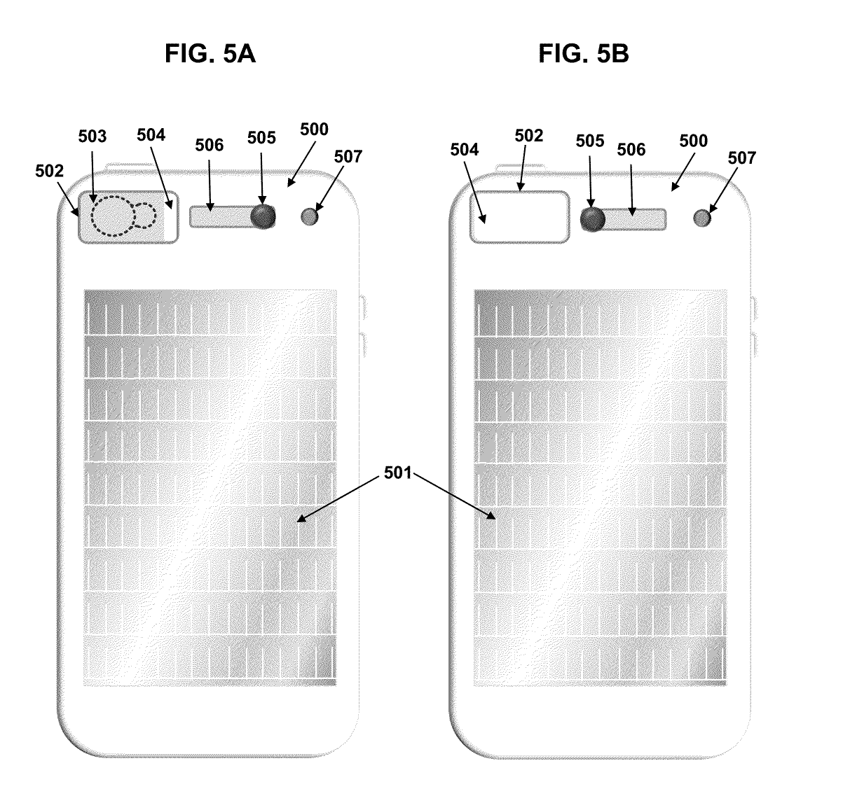

FIGS. 5A and 5B collectively illustrate the backside of one embodiment of the privacy case 500 in operational position on a smartphone mobile device. FIG. 5A shows the rear view of the privacy case with a rear visual privacy component, a shutter 504, in non-operative position relative to a rear mobile device camera lens 503 exposed via a cutout 502—which may be open or contain a transparent material for better protection of the device—in the privacy case 500 to enable user-elected camera imaging. FIG. 5B shows the rear view of the privacy case with a rear visual privacy component, a shutter 506, in operative position as to fully obstruct visual data collection from a mobile device's rear camera. To the right of the privacy shutter 504 is a privacy shutter control mechanism whereby a user-controlled slidable switch 505 can be moved side-to-side in a switch track 506, thus causing the privacy shutter to open and close as desired. FIG. 5A depicts the switch 505 in open position on the track 506, and FIG. 5B depicts the switch 505 in closed position on the track 506.

Both FIGS. 5A and 5B also depict a notifier that signals activity when an electronic privacy function is active (i.e., when the noise generator is on). In one embodiment, a small light-emitting diode (LED) 507 is situated in the casing such that it is exposed for user visibility on the outside of the case and connected to the noise-generator circuitry embedded in the casing 500 as to enable LED activation via the noise-generator's power source when the noise-generator is active.

As further illustrated in both FIGS. 5A and 5B, one embodiment of the privacy and protection mobile device case enables charging of the system's rechargeable battery by harnessing solar power. Such embodiment houses a photovoltaic cell system 501 that can be exposed to light when the case is face-down on a surface or when the cell is otherwise exposed to light. The photocell 501 is connected to a solar battery and the solar battery is electrically connected to the charging circuit of the electrical components of the privacy system.

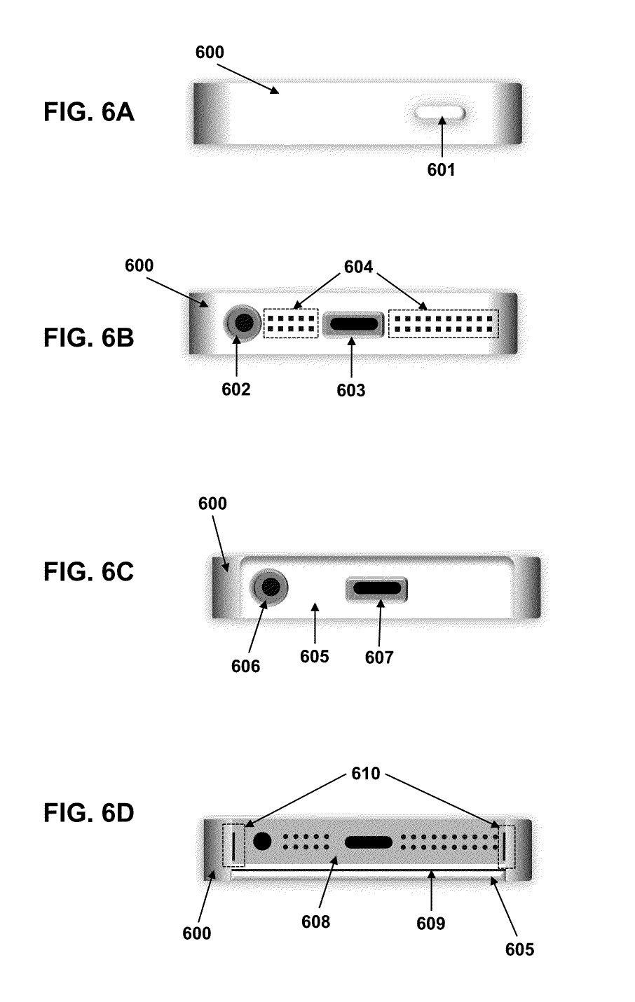

FIGS. 6A and 6B collectively depict the top and bottom views, respectively, of a unified embodiment of the privacy case in operational position on a smartphone. FIG. 6A illustrates the top view of the unified privacy case showing the casing 600 and an allowance for the power function 601 of a smartphone. FIG. 6B illustrates the bottom view of the unified privacy case showing the casing 600 having allowances for the audio input 602, power port 603 and speaker functions 604 of the smartphone. FIGS. 6C and 6D collectively illustrate the closed-gate and open-gate bottom views, respectively, of a gated embodiment of the privacy case in operational position on a smartphone. FIG. 6C illustrates the bottom view of the gated privacy case in closed-gate position, showing the casing 600 with gate 605 in closed position having allowances for the audio input 602 and power port 603 of the smartphone. FIG. 6D illustrates the bottom view of the gated privacy case in open-gate position, showing the casing 600 with gate 605 in open position, thereby exposing the bottom of the smartphone 608, as well as the circuit connecting means 609 and the circuit end means 610.

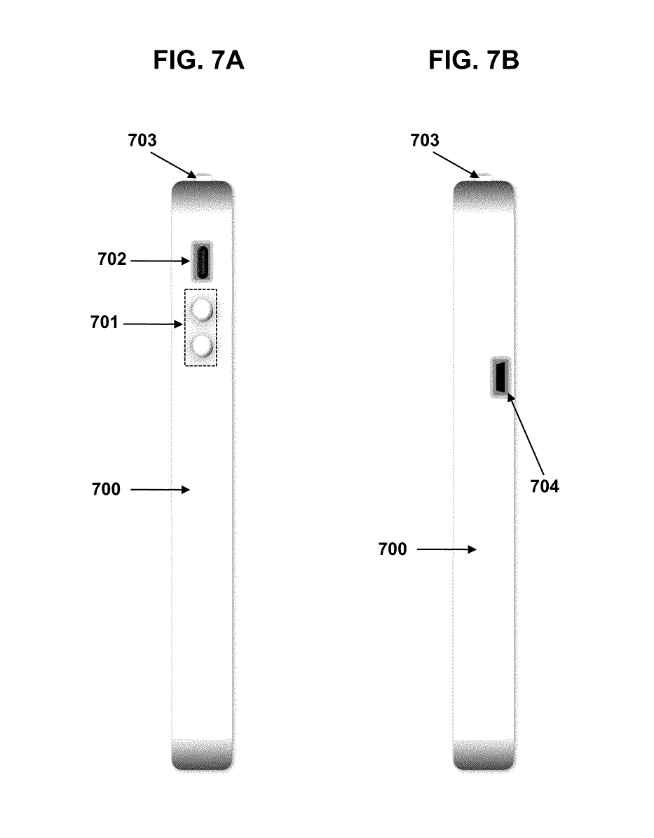

FIGS. 7A and 7B collectively depict the side views of a gated embodiment of the privacy case in operational position on a smartphone. FIG. 7A illustrates the left said view showing the casing 700 with allowances for volume 701, sound on/off 702 and power 703 controls of the smartphone. FIG. 7B illustrates the right side of the casing 700 showing the power port 704 of the privacy case and an allowance for the power function 703 of the smartphone.

As to further discussion of the manner of usage and operation of the present invention, the same should be apparent from the above description. With respect to the above description then, it is to be realized that the optimum dimensional relationships for the parts of this invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention, the use of which results in a mobile user device privacy and protection system that:
enables a mobile device user to optionally and manually mask the content of data remotely acquired or inadvertently transmitted from a user's mobile device;
enables a user to easily and independently control the audio and visual privacy functions with confidence that the desired function is enabled; and
simultaneously provides the protection desired and expected of any standard commercially available mobile device case.

Although the description presented heretofore contains specificities for the benefit of illustration, these should not be construed as limiting the scope of the embodiments but rather as illustrative examples of some of the several embodiments. Thus, the scope of the embodiments should be determined by the appended claims and their legal equivalents rather than by the examples provided.

What is claimed is:

1. A case for privacy and physical protection for a host user device having at least one user-enabled privacy means, said case comprising:
a casing made of a sturdy material, such as a rigid polymer, having a back panel, a top wall, a bottom wall and two opposing side walls, each wall being deeper than the depth of the target user device;
a battery;
at least one micro speaker;
at least one electrical sound generator, such as a white noise maker, associated with at least one said speaker;
an electrical connector whereby said speaker and noise generator are engaged via connection to the first electrical connector;
at least one user-controlled electrical circuit having a circuit disruption means, whereby said battery and noise generator are engaged via said circuit disruption means;
an inner tray positioned atop the electrical components (i.e., battery, noise generator, speaker, and electrical connectors) fitting snuggly inside the casing and securely abutting the top and side walls of the casing, having an aperture and aperture cover sized to enable removal of said battery, said casing and inner tray being configured to receive the mobile device such that a back of the mobile device covers the aperture and aperture cover.

2. The case of claim 1 further comprising at least one user-controlled camera lens obstruction means.

3. The case of claim 1 further comprising a notification means, such as an LED light, that is visible to the user when the sound generator is in operational position on the host user device.

4. The case of claim 1 wherein said battery is rechargeable and further comprising a battery charging port situated in a side wall of the casing and configured for a standard charging system, such as micro-USB, said rechargeable battery being connected to said battery charging port by electrical circuitry.

5. The case of claim 1 further comprising solar cells electrically connected to a power storage unit for storing the electrical energy generated by solar cells connected to a battery charging circuit configured via a configuration means to charge said battery connected to said noise generator and/or the battery of the user device.
